(19) United States
(12) Patent Application Publication
(10) Pub. No.: US 2014/0174381 A1
(43) Pub. Date: Jun. 26, 2014

(54) THERAPY ANIMAL GARMENT

(71) Applicant: CANINE THERAPY CORPS, INC., Chicago, IL (US)

(72) Inventors: Callandre A. Cozzolino, Chicago, IL (US); Charity A. Simpson, Chicago, IL (US)

(73) Assignee: CANINE THERAPY CORPS, INC., Chicago, IL (US)

(21) Appl. No.: 13/724,018

(22) Filed: Dec. 21, 2012

(51) Int. Cl. A01K 13/00

(52) U.S. Cl. CPC A01K 13/006
USPC 119/863

(57) ABSTRACT

A therapy animal garment for teaching and assisting fine motor skills is disclosed. The therapy animal garment may include a number of segments that are joined together using various different fasteners. One or more of the segments may be configured to attach to a therapy animal. In some instances, various segments of a therapy animal garment may be attached to each other using a variety of fasteners. A therapy animal garment may be provided to a therapy patient to allow the patient to improve motor skills through the repetition. The patient may practice fastening and unfastening various fasteners of a therapy animal garment to dress or undress a therapy animal.

### BACKGROUND

In some situations, adults and children can suffer a loss of fine motor skills due to an accident or illness. In some cases, persons may lose the ability to perform some regular daily tasks due to a loss or degradation of fine motor skills. Additionally, in some circumstances, children may have difficulty with developing fine motor skills or with learning basic activities of daily living. In some cases, it is possible for adults or children to improve fine motor skills and learn activities of daily living through repetition of basic activities such as zipping zippers, tying shoe laces, and buttoning buttons. A device or apparatus which teaches and assists in improving fine motor skills while keeping the individual focused and claim during a therapy session would be beneficial.

### SUMMARY

The following presents a simplified summary in order to provide a basic understanding of some aspects as described herein. The summary is not an extensive overview of all aspects. It is neither intended to identify key or critical elements nor to delineate the scope of the present disclosure. The following summary merely presents various example concepts in a simplified form as a prelude to the more detailed description below.

A therapy tool such as a therapy animal garment may refine or teach fine motor skills while also keeping a patient motivated during a therapy session. The therapy animal garment may include a number of segments that are joined together using various different fasteners. One or more of the segments can be configured to attach to a therapy animal. For example, a segment can be configured to attach to a dog by at least partially circumscribing the body of the dog. In this example, the segment can be secured to the dog using a hook and loop fastener. As another example, a segment can be attached to another therapy animal that is suitable for engaging in activities with therapy patients by wrapping one or more straps around the torso of the therapy animal.

In some instances, various segments of a therapy animal garment can be attached to each other using a variety of fasteners such as zippers, buttons, buckles, toggles, snaps, hook and loop fasteners, hook type fasteners, plastic safety pins, or string. For example, a first segment can be attached to a second segment using a zipper. As another example, a third segment can be attached to the second segment using a string or “shoe lace” that is laced through one or more eyelets of the third and second segments. As another example, a first segment can be attached to a segment using one or more buttons. A therapy animal garment can be provided to a therapy patient to allow the patient to improve motor skills through repetition. The patient can practice fastening and unfastening various fasteners of a therapy animal garment to dress or undress a therapy animal.

In some instances, the presence of a therapy animal during therapy sessions can help improve the effectiveness of physical therapy treatments. For example, when a therapy garment is affixed to a therapy animal, the therapy garment can conform to the natural contours of the therapy animal's body. This can give patients experience in manipulating various fasteners of the therapy garment imitating similar contours that may be found on an individual's body. In some situations, the presence of the therapy animal during therapy sessions can please patients and act as motivation for the patients to perform tasks during the therapy session. Many people enjoy engaging with and playing with dogs, cats, and other animals. The act of dressing an animal by connecting various garment segments of a therapy garment using various fasteners can be framed as a game. This can provide additional motivation for a patient to complete the tasks required to assemble the therapy garment.

In some situations, the therapy animal can be used to provide rewards for successfully completing tasks during a therapy session. For example, a patient can be rewarded for successfully attaching two therapy garment segments to each other using one or more fasteners by being allowed to brush the therapy animal for a period of time. In some situations, the presence of a therapy animal during a physical therapy session can have a calming effect on a patient. This can allow the patient to more readily control anger, frustration, or other less desirable emotions.

### BRIEF DESCRIPTION OF THE DRAWINGS

FIG. 1 shows one embodiment of a therapy animal garment attached to a therapy animal in accordance with one aspect of the disclosure.

FIG. 2 shows one embodiment of a therapy animal garment in a semi-assembled state in accordance with one aspect of the disclosure.

FIG. 3 shows an underside view of the therapy animal garment of FIG. 2 in accordance with one aspect of the disclosure.

FIG. 4 shows one embodiment of a therapy animal garment in a disassembled state in accordance with one aspect of the disclosure.

FIG. 5 is a flow diagram of a method for using a therapy animal garment to improve fine motor skills in accordance with one aspect of the disclosure.

Like reference numerals throughout the figures indicate like elements.

### DETAILED DESCRIPTION

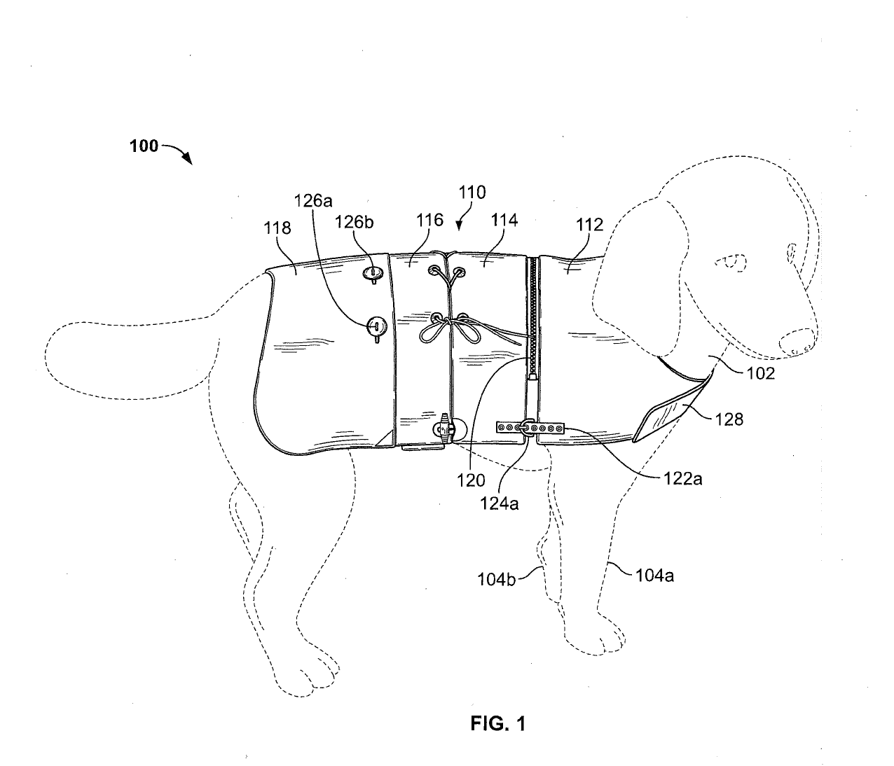

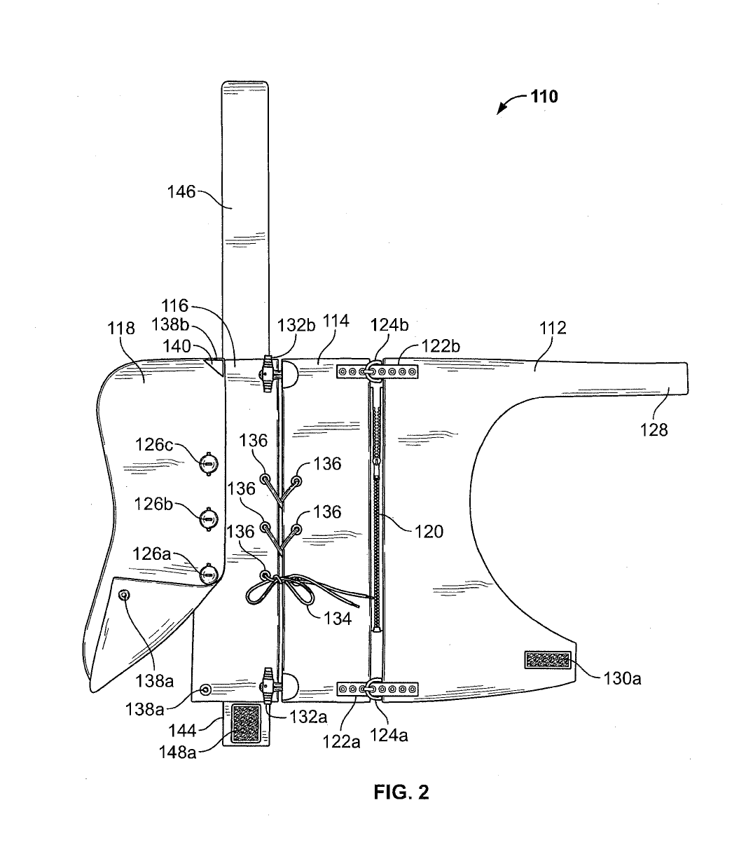

FIG. 1 shows a garment 110 releasably attached to a therapy animal 100. In the example shown, the therapy animal 100 is a dog. In other embodiments, the therapy animal could any animal that is suitable for engaging in activities with therapy patients. The garment 110 includes a plurality of garment segments 112, 114, 116, and 118. Each of the garment segments 112, 114, 116, and 118 may be attached to at least one adjacent garment segment by one or more fasteners. For example, garment segment 112 may be attached to garment segment 114 by a zipper 120. Garment segment 112 may also be attached to garment segment 114 by a strap 122a that may be attached to the garment segment 114 and engaged with a buckle 124a that may be attached to the garment segment. As another example, garment segment 116 may be attached to garment segment 118 by buttons 126a and 126b. The various fasteners used to attach the garment segments 112, 114, 116, and 118 to each other as well as various fasteners that could be used in alternative embodiments are discussed in greater detail with reference to FIG. 2 below.

The garment segment 112 may include a strap 128 for engaging a neck 102 of the therapy animal 100. In the example shown, the strap 128 circumscribes the neck 102 in order to secure the garment 110 to the therapy animal 100. In some embodiments, the strap 128 can be secured in place using one or more fasteners. For example, the strap 128 can be secured in place using a hook and loop fastener. As another example, the strap 128 can be secured in place using a snap. As another example, strap 128 can be secured in place using a hook type fastener. In other embodiments, the garment 110 can be affixed to the therapy animal using different fasteners in addition to or alternative to the strap 128. For example, in some embodiment, the garment 110 can include sleeves. Front legs 104a and 104b of the therapy animal 100 can be inserted through the sleeves to affix the garment 110 to the therapy animal 100. As another example, in some embodiments, the garment 110 can include one or more straps that are configured to wrap around the underside of the torso of the therapy animal 100 to secure the garment 110 in place with respect to the therapy animal 100.

In some embodiments, the garment 110 can be used to assist with physical therapy to help patients with improving fine motor skills and practicing activities of daily living. For example, a patient can use the zipper 120 to attach the garment segment 114 to the garment segment 112 in order to improve motor skills and practice the daily living skill of zippering a zipper. As another example, a patient can use the buttons 126a and 126b to attach the garment segment 118 to the garment segment 116 in order to improve motor skills and practice the daily living skill of fastening buttons. The garment 110 can be used in therapy sessions to help improve fine motor skills for patients suffering or recovering from various different afflictions. For example, the garment 110 can be used in physical therapy sessions for patients recovering from strokes, patients who have experienced head trauma, patients who have experienced nerve damage, and developmentally disabled patients. In some embodiments, the garment 110 can be used to teach everyday living activities to children with autism or autism spectrum disorder. For example, the strap 122a and buckle 124a can be used to teach a child how to fasten a buckle.

The presence of the therapy animal 100 during therapy sessions can help improve the effectiveness of physical therapy treatments in several ways. When the garment 110 is affixed to the therapy animal 100, the garment 110 conforms to the natural contours of the therapy animal 100's body. This gives patients experience in manipulating the various fasteners of the garment 110 while the garment is being worn. This adds an extra dimension to the physical therapy over simply manipulating fasteners on an article of clothing that is not being worn by a person or therapy animal. Manipulating the fasteners of the garment 110 while the garment is being worn by the therapy animal 100 can more readily recreate the experience of manipulating fasteners on an article of clothing that is being worn by the patient, or by another person. For example, a patient may have young children or grandchildren who are still young enough to require assistance with getting dressed. Manipulating the fasteners of the garment 110 while the garment is affixed to the therapy animal 100 can more readily recreate the experience of dressing a young child.

In some situations, the presence of the therapy animal 100 during therapy sessions can please patients and act as motivation for the patients to perform tasks (such as manipulating the fasteners of the garment 110) during the therapy session. Many people enjoy engaging with and playing with dogs and other animals. The act of dressing the therapy animal 100 by connecting the garment segments 112, 114, 116, and 118 to each other can be framed as a game. This can provide additional motivation for a patient to complete the tasks required to assemble the garment 110. In some embodiments, the garment 110 can be a costume. For example, the garment segments 112, 114, 116, and 118 can be attached together by a patient in order to form a princess costume. As another example, the garment 110 can be a Santa costume. As yet another example, the garment 110 can be a super hero costume. In some embodiments, the enjoyment of the patient during the therapy session can be increased since the act of “playing dress up” with the therapy animal 100 can be viewed as more of a leisure activity that is to be enjoyed, rather than a therapy session that is to be endured.

In some situations, the therapy animal 100 can be used to provide rewards for successfully completing tasks during a therapy session. For example, a patient can be rewarded for successfully attaching the garment segment 112 to the therapy animal 100 by being allowed to pet the therapy animal 100 for a period of time. As another example, a patient can be rewarded for successfully attaching the garment segment 114 to the garment segment 112 by being allowed to engage in unstructured play time with the therapy animal 100.

In some situations, the presence of the therapy animal 100 during a physical therapy session can have a calming effect on a patient. This can allow the patient to more readily control anger, frustration, or other less desirable emotions. For example, for some patients, the act of improving fine motor skills relearning activities of daily living after a loss of motor function can be a frustrating experience. The presence and participation of the therapy animal 100 in a therapy session can help to calm a patient and relieve and/or divert frustration. For example, a patient can be allowed to pet the therapy animal 100 in order to help calm the patient. As another example, the patient may talk to the therapy animal 100 while practicing various skills using the garment 110 in order to stay calm during a therapy session. This calming effect can help the patient to control his or her emotions and stay focused on the task of improving motor skills and practicing activities of daily living.

FIG. 2 shows the garment 110 in an assembled state when the garment 110 is not affixed to a therapy animal. The garment 110 includes garment segments 112, 114, 116, and 118 as described above. The garment segment 112 includes the strap 128 for engaging a neck of a therapy animal, such as the therapy animal 100 from FIG. 1. In the embodiment shown, the garment segment 112 includes a hook and loop fastener portion 130a. The strap 128 can include a hook and loop fastener portion (not shown) that is configured to engage with the hook and loop fastener portion 130a when the garment 110 is affixed to a therapy animal. The hook and loop fastener portions can secure the strap 128 in place so that the garment 110 remains secured to the therapy animal. In other embodiments, other fasteners could be used to secure the strap 128 to a therapy animal, such as a hook type fastener, one or more snaps, one or more buttons, a zipper, one or more laces, one or more plastic safety pins, one or more buckles, one or more toggles, or one or more magnets.

In the embodiment shown, the garment segment 112 is attached to the garment segment 114 by a plurality of fasteners including the zipper 120, the strap 122a and buckle 124a, and a strap 122b and buckle 124b. During a therapy session, when the garment segment 112 is affixed to a therapy animal, a patient can work on improving fine motor skills and relearning activities of daily living by using the zipper 120, the strap 122a and buckle 124a, and the strap 122b and buckle 124b to affix the garment segment 114 to the garment segment 112. For example, the patient can use the zipper 120 to zip the garment segment 114 to the garment segment 112. The patient can then insert the strap 122a through the buckle 124a and buckle the buckle 124a to the strap 122a. The patient can then repeat this process to attach the strap 122b to the buckle 124b. In some embodiments, the garment segment 112 can be attached to the garment segment 114 using more or less fasteners than in the embodiment depicted. In some embodiments, fasteners other than those shown in FIG. 2 can be used to attach the garment segment 112 to the garment segment 114.

In the embodiment shown, the garment segment 114 is attached to the garment segment 116 by a plurality of fasteners including toggles 132a and 132b and a shoelace style string 134 looped through a plurality of eyelets 136. During a therapy session, a patient can practice activities of daily living and improve motor function by using the string 134 and the toggles 132a and 132b to attach the garment segment 116 to the garment segment 114. For example, the patient can thread the string 134 through the eyelets 136 in a crisscross pattern as depicted and tie the ends of the string 134 together to practice the skill of tying shoelaces. As another example, the patient can fasten the toggles 132a and 132b to attach the garment segment 116 to the garment segment 114. In some embodiments, the garment segment 114 can be attached to the garment segment 116 using more or less fasteners than in the embodiment depicted. In some embodiments, fasteners other than those shown in FIG. 2 can be used to attach the garment segment 114 to the garment segment 116.

In the embodiment shown, the garment segment 116 includes straps 144 and 146 configured to secure the garment 110 to a therapy animal by wrapping around the underside of the torso or stomach of the therapy animal. The strap 144 can include a hook and loop fastener portion 148a that is configured to engage with a hook and loop fastener portion (not shown) of the strap 146 when the garment 110 is affixed to a therapy animal. The hook and loop fastener portions can secure the strap 144 to the strap 146 so that the garment 110 remains secured to the therapy animal. In other embodiments, other fasteners could be used to secure the strap 144 to the strap 146 such that the garment segment 116 is securely attached to a therapy animal. For example, the strap 144 can be secured to the strap 146 using a hook type fastener, one or more snaps, one or more buttons, a zipper, one or more laces, one or more plastic safety pins, one or more buckles, one or more toggles, or one or more magnets.

In the embodiment shown, the garment segment 116 is attached to the garment segment 118 by a plurality of fasteners including buttons 126a, 126b, and 126c, and snaps 138a and 138b. The buttons 126a, 126b, and 126c, and snaps 138a and 138b can be manipulated by a patient during a physical therapy session to help the patient improve fine motor skills and practice activities of daily living. For example, the patient can fasten the buttons 126a, 126b, and 126c in order to attach the garment segment 116 to the garment segment 118. As another example, the patient can snap the snaps 138a and 138b to attach the garment segment 118 to the garment segment 116. In some embodiments, the garment segment 118 includes one or more fabric patches 140 to indicate the location of one or more of the snaps 138a and 138b. The fabric patch 140 can help a patient to readily identify the location of the snap 138b when the patient is attempting to attach the garment segment 118 to the garment segment 116. In some implementations, the color of the fabric patch 140 can be different than a main color of the garment segment 118 in order to visually stand out. For example, the main body of the garment segment 118 can be colored red while the fabric patch 140 is colored blue. In some embodiments, other fasteners of the garment 110 can be colored so as to be more readily identifiable by patients. For example, the buttons 126a, 126b, and 126c can be colored bright yellow, or the string 134 can be colored bright pink In some embodiments, the garment segment 116 can be attached to the garment segment 118 using more or less fasteners than in the embodiment depicted. In some embodiments, fasteners other than those shown in FIG. 2 can be used to attach the garment segment 116 to the garment segment 118.

Although a particular embodiment of the garment 110 is shown in FIG. 2, one skilled in the art would recognize that the various fasteners of the garment 110 could be exchanged with other fasteners. For example, the garment segment 118 could be attached to the garment segment 116 by a zipper. As another example, the garment segment 112 could be attached to the garment segment 114 by a shoelace style string and eyelet fastener. As yet another example, any of the garment segments 112, 114, 116, and 118 could be attached to an adjacent garment segment using laces, string, toggles, zippers, strap and buckle fasteners, hook and loop fasteners, buttons, snaps, hook type fasteners, or plastic safety pins. In some embodiments, a patient can attach one of the garment segments 112, 114, 116, and 118 to an adjacent garment segment by using thread to join the adjacent garment segments together.

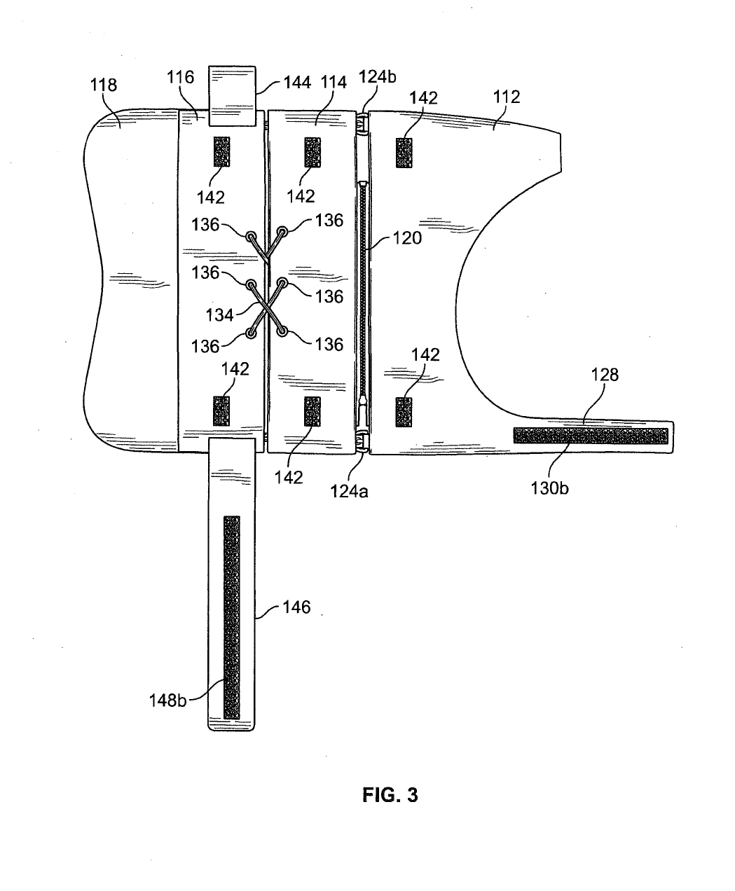

FIG. 3 shows an underside view of the garment 110. In the embodiment shown, the strap 128 includes a hook and loop fastener portion 130b that is configured to engage with the hook and loop fastener portion 130a shown in FIG. 2 in order to secure the garment segment 112 to a therapy animal. In some embodiments, the strap 146 of garment segment 116 includes a hook and loop fastener portion 148b that is configured to engage with the hook and loop fastener portion 148a of the strap 144 shown in FIG. 2. The hook and loop fastener portion 148a can be secured to the hook and loop fastener portion 148b in order to secure the garment portion 116 to a therapy animal. For example, the straps 144 and 146 can be wrapped around the torso or stomach of a therapy animal such that the hook and loop fastener portion 148a engages the hook and loop fastener portion 148b and the straps 144 and 146 in combination with the garment segment 116 encircle the torso or stomach of the therapy animal.

In some embodiments, the garment 110 includes one or more detachable protective fabric segments (not shown) configured to prevent hair or fur of a therapy animal from becoming entangled in the one or more of the fasteners of the garment 110 when a patient is engaged in the act of manipulating the fasteners of the garment 110. In some embodiments, the garment 110 can include one or more hook and loop fastener portions 142 for releasably attaching one or more detachable protective fabric segments to the garment 110. For example, one of the protective fabric segments can be attached to one or more of the garment segments using the hook and loop fastener portions 142 of the garment 110 to prevent hair of a therapy animal from becoming entangled in the zipper 120 when a patient is engaged in the act of attaching the garment segment 114 to the garment segment 112 using the zipper 120. In this example, the protective fabric segment is configured to overlay the gap between garment segment 112 and garment segment 114 when the garment segments 112 and 114 are attached to each other or positioned in relative proximity to each other prior to being attached to each other.

As another example, one of the protective fabric segments can be attached to the garment segments 114 and 116 using one or more of the hook and loop fastener portions 142 of the garment 110 to prevent hair of a therapy animal from becoming entangled with the string 134 when a patient is engaged in the act of securing the garment segment 114 to the garment segment 116 utilizing the string 134. In this example, the patient can lace the string 134 through the eyelets 136 and tie ends of the string 134 together (as shown in FIG. 2) in order to secure the garment segment 114 to the garment segment 116. The detachable protective fabric segment can be configured to overlay the gap between the garment segment 114 and the garment segment 116 to prevent the string 134 from becoming entangled in hair of a therapy animal to which one or more garment segments of the garment 110 are attached. In some embodiments, one or more detachable protective fabric segments can be used to prevent other fasteners of the garment 110 from becoming entangled in the hair of a therapy animal.

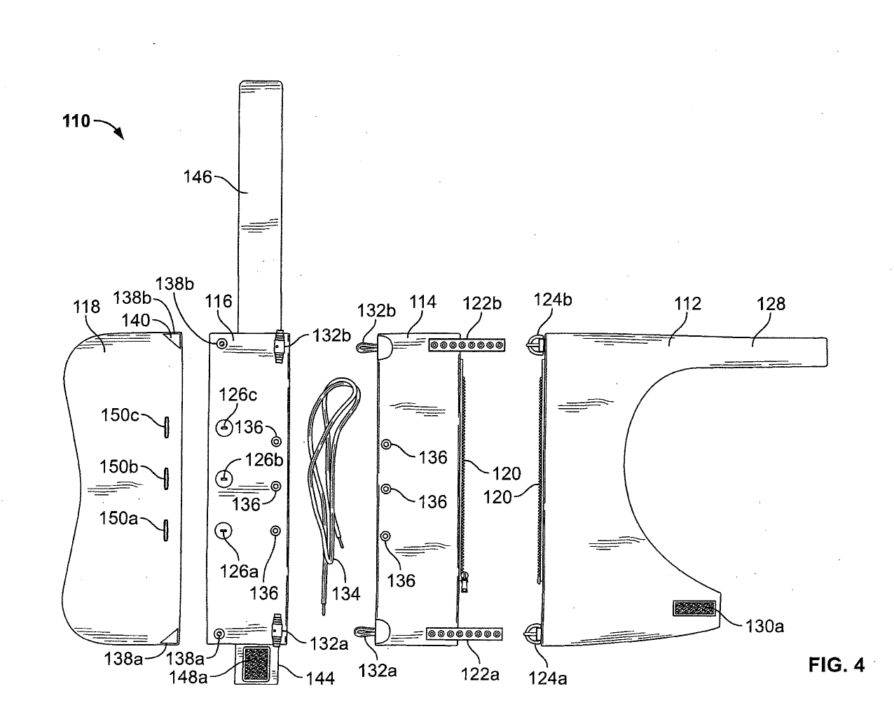

FIG. 4 shows the garment 110 in a disassembled state. In the embodiment shown, the various garment segments 112, 114, 116, and 118 of the garment 110 are detached from each other. In this configuration, the buckles 124a and 124b are detached from the straps 122a and 122b; the zipper 120 is fully unzipped to create two zipper portions; the components of the toggles 132a and 132b are detached from each other; the string 134 is not threaded through the eyelets 136; and the portions of the snaps 138a and 138b are not attached. Garment segment 118 includes button receiving apertures 150a, 150b, and 150c for receiving the buttons 126a, 126b, and 126c respectively when the garment segment 116 is attached to the garment segment 118.

In some embodiments of a method for using the garment 110, the garment 110 can be provided to therapy patient or other user in a disassembled state as shown in FIG. 4. The user can improve fine motor skills and practice activities of daily living by attaching the garment segments 112, 114, 116, and 118 to a therapy animal one at a time. For example, a user can attach the garment segment 112 to a therapy animal by wrapping the strap 128 around a neck of the therapy animal and securing the garment segment 112 in place by engaging the hook and loop fastener portion 130b (shown in FIG. 3) to the hook and loop fastener portion 130a. The user can then attach the garment segment 114 to the garment segment 112 by zipping the two portions of the zipper 120 together and/or by attaching the buckles 124a and 124b to the straps 122a and 122b respectively.

In some embodiments, the user can attach the garment segment 116 to the garment segment 114 by threading the string 134 through one or more of the eyelets 136 of the garment segments 114 and 136 and tying ends of the string 134 (as shown in FIG. 2). The user can also manipulate the toggles 132a and 132b to attach the garment segment 114 to the garment segment 116. In some implementations, the user can secure the garment segment 116 to the therapy animal by wrapping the strap 146 around the stomach or torso of the therapy animal and engaging the hook and loop fastener portion 148b (shown in FIG. 3) to the hook and loop fastener portion 148a.

In some embodiments, the user can attach the garment segment 118 to the garment segment 116 by snapping the snaps 138a and 138b. The user can also attach the garment segment 118 to the garment segment 116 by inserting the buttons 126a-c through the apertures 150a-c respectively.

In some embodiments of a method for using the garment 110, the garment 110 can be provided to therapy patient or other user in an assembled state and attached to a therapy animal as shown in FIG. 1. The user can improve fine motor skills and practice activities of daily living by detaching the various garment segments 112, 114, 116, and 118 from each other. In some embodiments, the user can accomplish this by unfastening the various fasteners of the garment 110 to detach the garment segments from each other.

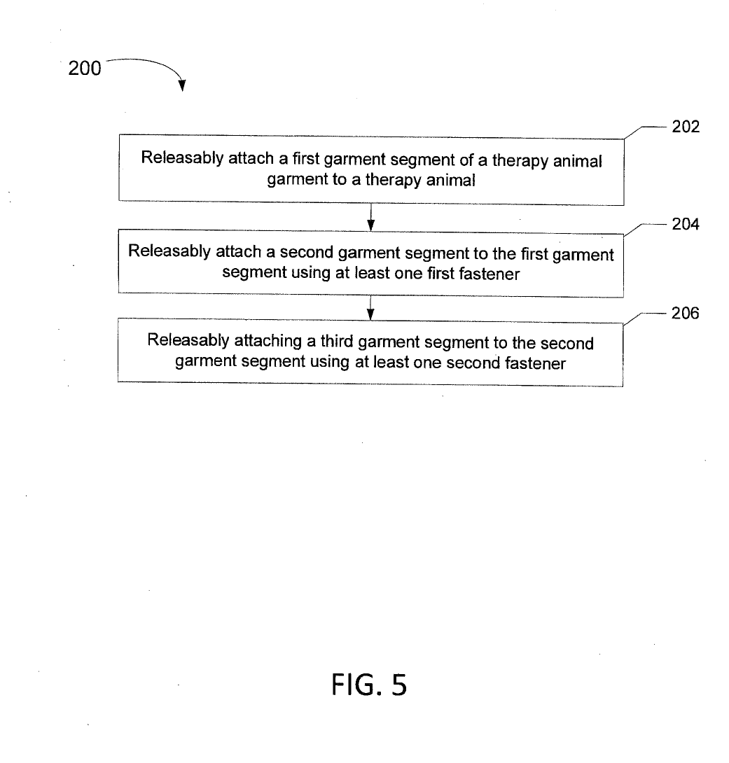

FIG. 5 shows a method 200 for using a therapy animal garment to improve fine motor skills and practice activities of daily living. For example, the method 200 can be practiced using the garment 110 of FIG. 1. The method 200 includes a step 202 of releasably attaching a first garment segment of a therapy animal garment to a therapy animal. For example, referring to FIG. 1, a person can attach the garment segment 112 to the therapy animal 100 using the strap 128. In some embodiments, the strap 128 can include a hook and loop fastener portion that is configured to engage a second hook and loop fastener portion of the garment segment 112 in order to secure the garment segment 112 to the therapy animal 100. As another example, some embodiments of a garment segment can include one or more sleeves for releasably attaching to a therapy animal. For example, referring to FIG. 1, the garment segment 112 can include sleeves and the garment segment 112 can be attached to the therapy animal 100 by inserting the front legs 104a and 104b of the therapy animal 100 through the sleeves.

In some embodiments, the first garment segment can include one or more straps that are configured to engage an underside of a torso of the therapy animal in order to secure the first garment segment in place. For example, referring to FIG. 2, the first garment segment can be the garment segment 116. The first garment segment can include straps such as the straps 144 and 146 of the garment segment 116. The straps 144 and 146 can be wrapped around the torso or stomach of a therapy animal such that fastener portions attached to each of the straps 144 and 146 are engaged to releaseably secure the garment segment 116 to the therapy animal. In some embodiments, the first garment segment can be releasably attached to the therapy animal by clipping the first garment segment to a collar worn by the therapy animal.

At step 204, a second garment segment is releasably attached to the first garment segment using at least one first fastener. For example, the second garment segment can be attached to the first garment segment using a zipper. As another example, the second garment segment can be attached to the first garment segment using a zipper in combination with one or more buckle and strap fasteners. As another example, the second garment segment can be attached to the first garment segment using one or more buttons. As yet another example, the second garment segment can be attached to the first garment segment using a string laced through a series of eyelets. In this example, eyelets can be located on both the first and second garment segments and one or more strings can be laced through the eyelets to attach the second garment segment to the first garment segment. In some implementations, the second garment segment is releasably attached to the first garment segment such that the second garment segment is in contact with the therapy animal.

At step 206, a third garment segment is releasably attached to the second garment segment using at least one second fastener. In some embodiments, the second fastener is of a different type than the first fastener. For example, the first fastener can be a zipper while the second fastener includes one or more snaps that are used to attach the third garment segment to the second garment segment. As another example, the first fastener can be a hook and loop fastener while the second fastener is one more toggles used to attach the third garment segment to the second garment segment. In some implementations, the third garment segment is releasably attached to the second garment segment such that the third garment segment is in contact with the therapy animal.

In some embodiments, the method 200 can be performed by a patient as part of a physical therapy session for improving fine motor skills and practicing activities of daily living. For example, the method 200 can be performed by a patient recovering from a stroke, a patient who has experienced nerve damage, or any patient who has experienced an event that has led to a loss of motor control. In some embodiments, the method 200 can be performed by developmentally delayed patients. In some embodiments, the method 200 can be performed by young children to help the children learn basic life skills, such as manipulating zippers, buttons, buckles, laces, snaps, hook type fasteners, hook and loop type fasteners, toggles, and other fasteners.

In some embodiments, the steps of the method 200 can be performed in a different order. For example, the step 204 of releasably attaching a second garment segment to the first garment segment can be performed prior to the step 202 of releasably attaching a first garment segment to a therapy animal. In some embodiments, the method 200 can include additional steps. For example, the method 200 can include an additional step of releasably attaching a fourth garment segment to the third garment segment using at least one third fastener. Several embodiments have been described. One skilled in the art would realize that certain embodiments not explicitly described her in would also fall within the scope of forgoing claims.

Aspects of the disclosure have been described in terms of illustrative embodiments thereof. While illustrative systems and methods as described herein embodying various aspects of the present disclosure are shown, it will be understood by those skilled in the art, that the disclosure is not limited to these embodiments. The foregoing description is not intended to be exhaustive or to limit embodiments to the precise form disclosed, and modifications and variations are possible in light of the above teachings or may be acquired from practice of various embodiments. For example, each of the features of the aforementioned illustrative examples may be utilized alone or in combination or subcombination with elements of the other examples. For example, any of the above described systems and methods or parts thereof may be combined with the other methods and systems or parts thereof described above. For example, one of ordinary skill in the art will appreciate that the steps shown in the illustrative figures may be performed in other than the recited order, and that one or more steps illustrated may be optional in accordance with aspects of the disclosure.

What is claimed is:

1. An animal garment comprising:
a first garment segment configured to releasably attach to an animal by at least partially circumscribing a portion of the animal;
a second garment segment releasably attached to the first garment segment by at least one first fastener; and
a third garment segment releasably attached to the second garment segment by at least one second fastener, wherein the second fastener is of a different type than the first fastener.

2. The animal garment of claim 1, wherein the at least one first fastener comprises a zipper.

3. The animal garment of claim 1, wherein the at least one first fastener comprises a zipper and at least one strap and buckle fastener.

4. The animal garment of claim 1, wherein the at least one second fastener comprises a lace and eyelet fastener.

5. The animal garment of claim 1, wherein the at least one second fastener comprises a lace and eyelet fastener and at least one toggle.

6. The animal garment of claim 1, further comprising a fourth garment segment releasably attached to the third garment segment by at least one third fastener, wherein the third fastener is of a different type than the second fastener.

7. The animal garment of claim 6, wherein the at least one third fastener comprises buttons.

8. The animal garment of claim 6, wherein the at least one third fastener comprises buttons and at least one snap fastener.

9. The animal garment of claim of claim 1, wherein at least one of the first and second fasteners comprises a snap fastener.

10. The animal garment of claim 9, wherein a position of the snap fastener is indicated by a section of fabric having a different color than a primary color of the garment segment that includes the snap fastener.

11. The animal garment of claim 1, wherein the first garment segment is configured to releasably attach to the animal through use of a hook and loop fastener.

12. The animal garment of claim 1, further comprising at least one fabric portion configured to prevent hair of the animal from becoming entangled with at least one of the first and second fasteners.

13. A method for improving fine motor skills comprising:
releasably attaching a first garment segment of an animal garment to a therapy animal;
releasably attaching a second garment segment to the first garment segment using at least one first fastener such that at least a portion of the second garment segment is in contact with the therapy animal; and
releasably attaching a third garment segment to the second garment segment using at least one second fastener such that at least a portion of the third garment segment is in contact with the therapy animal, wherein the second fastener is of a different type than the first fastener.

14. The method of claim 13 wherein releasably attaching the first garment segment to the therapy animal comprises attaching the first garment segment to the therapy animal such that the first garment segment engages the neck of the therapy animal.

15. The method of claim 13, wherein releasably attaching the second garment segment to the first garment segment comprises zipping a zipper.

16. The method of claim 13, wherein releasably attaching the third garment segment to the second garment segment comprises tying a lace.

17. The method of claim 13, wherein at least one of the first and second fasteners comprises a button.

18. The method of claim 13, wherein at least one of the first and second fasteners comprises a snap fastener.

19. The method of claim 13, further comprising, petting the therapy animal responsive to successfully fastening at least one of the first and second fasteners.

20. A therapy animal garment comprising:
a first garment segment configured to releasably attach to a therapy animal using a hook and loop fastener;
a second garment segment releasably attached to the first garment segment by at least one zipper and at least one strap and buckle fastener;
a third garment segment releasably attached to the second garment segment by at least one lace and eyelet fastener and at least one toggle; and
a fourth garment segment releasably attached to the third garment segment by at least one button and at least one snap fastener.
